(19) United States
(12) Patent Application Publication
(10) Pub. No.: US 2012/0041737 A1
(43) Pub. Date: Feb. 16, 2012

(54) Dynamic reservoir characterization

(75) Inventors: Kevin Hermansen, Oslo (NO); Eigil Samset, Oslo (NO)

(73) Assignee: KONGSBERG OIL & GAS TECHNOLOGIES AS, Sandvika (NO)

(21) Appl. No.: 13/208,374

(22) Filed: Aug. 12, 2011

Related U.S. Application Data
(60) Provisional application No. 61/373,288, filed on Aug. 13, 2010.

(51) Int. Cl. G06G 7/48

(52) U.S. Cl. 703/10

(57) ABSTRACT

Method for dynamic reservoir characterization by generating, and visually presenting a three-dimensional reservoir model defined by a data set of cells, each cell describing a geometric shape in space and time having an array of physical properties.

### CROSS-REFERENCE TO RELATED APPLICATIONS

This application claims the benefit under 35 USC §119 to U.S. Provisional application 61/373,288 file 13 Aug., 2010.

### FIELD OF THE INVENTION

The present invention relates to reservoir characterization. More specifically, the invention relates to a method for dynamic reservoir characterization by generating and visually presenting a three-dimensional reservoir model.

### BACKGROUND OF THE INVENTION

As used in the context of the present invention, a reservoir model is a computer-based representation of a region of the subsurface, such as a petroleum reservoir. Most commonly, models built for petroleum applications are in the form of a three-dimensional grid of individual model units or blocks (also referred to as cells). The entire set of cells constitutes a geologic model and represents a volume in the subsurface which constitutes a reservoir. Each cell represents a unique portion of the subsurface, so the cells may not overlay each other.

There is however a need for a flexible and efficient way of characterizing dynamic reservoir behaviour.

The present invention presents novel features for characterizing a reservoir. This is done by generalizing the concept of calculating new values for a cell based on other values at different time steps for the same cell to several dimensions, and more specifically how this can be done, such as time derivation, spatial filtering and statistical evaluations of several data sets.

### SUMMARY OF THE INVENTION

The present invention is a method for dynamic reservoir characterization by generating and visually presenting a three-dimensional reservoir model defined by a data set of cells, each cell describing a geometric shape in space and time having an array of physical properties, where the method comprises the following main steps:

a) computing a new physical property for each of said cells as a function of existing properties for same cells and/or adjacent cells;

b) if existing properties for same cells are used in said computing, then letting the new physical properties of these cells be a function of existing properties for another time step than the current time step for these same cells, and

c) presenting an image of at least a portion of the reservoir model on a display, said image comprises cells with a color defined by the value of the new physical property according to a predefined color map.

### DETAILED DESCRIPTION OF A GENERAL EMBODIMENT

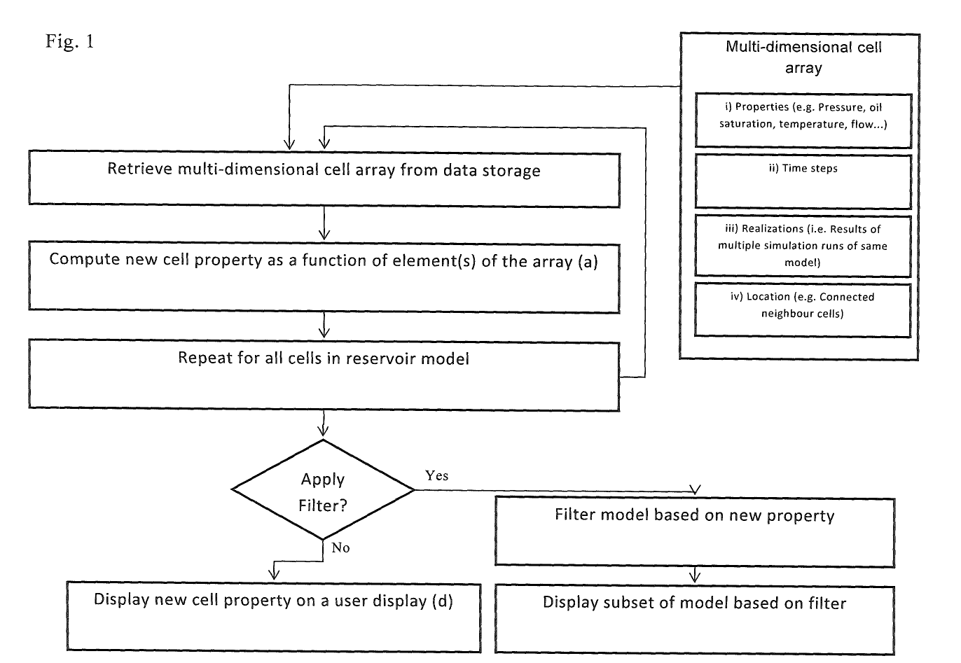

The invention will now be described in more detail with reference to FIG. 1 showing the different steps comprised in the method for providing a dynamic reservoir characterization by generating and visually presenting a three-dimensional reservoir model.

The method is performed subsequent to running the reservoir model through a reservoir simulator for simulating the change of physical characteristics at different time steps. The same reservoir model may also be run several times through the reservoir simulator, with different input data, to create an ensemble of different physical characteristics at different time steps.

The input data used for performing the method comprises multi-dimensional cell arrays with different geometric shapes in space and time for describing different physical properties at specific locations at a specific time in a reservoir to be characterized.

More specifically, a multi-dimensional cell array comprises physical properties such as pressure, oil saturation, temperature, flow characteristics etc. of a cell. It further comprises information of the location of the cell and connected neighbour cells.

These variables will change over time, and the different realizations, i.e. results of multiple simulation runs at different time steps are also comprised in the multi-dimensional cell array.

The first step of the inventive method is to compute a new physical property for each of said cells as a function of existing properties, described by said multi-dimensional cell array, and where this is done at a different time step for the same cells and/or adjacent cells.

An alternative way of performing the computing is to apply a spatial filter kernel to each cell. In this alternative different properties of other cell locations are used. This will provide spatial filtering for enhancing spatial gradients in the image, e.g. smoothing or emphasizing edges/gradients.

Corresponding cells in a series of different realizations, i.e. a complete runs with a series of steps possibly differing by different input data or parameters, of the same reservoir model may also be considered. This will provide information of the statistical agreement between the corresponding cells, e.g. standard deviation, entropy, convolution etc.

The second step of the method is to check whether the existing properties for same cells are used in said computing. If this is the case, then let the new physical property of these cells be a function of existing properties for another time step than the current time step for these same cells.

The function in the second step can be the time derivative of the existing property of the cell calculated by using two or more time steps to approximate the derivative. This can be done by taking the average of an estimate two or three steps forward of the derivative, and an estimate two or three steps backward of the derivative.

The third and final step is to present an image of at least a portion of the reservoir model on a display, where said image comprises cells with a color defined by the value of the new physical property according to a predefined color map.

The third and visualizing step may alternatively be replaced by the step of first filtering the cells of the reservoir model using thresholds based on the value of the new property and presenting the resulting volume of filtered cells on a display with colors defined by any property. In this way the cells with the latest calculated values are not displayed. The values are however used together with the threshold to filter which cells in the reservoir model that shall be displayed. The property to be displayed for the filtered data set can be chosen by user.

The novel features in the inventive method presented is to generalize the concept of calculating new values for a cell based on other values at different time steps for the same cell to several dimensions, and more specifically how this can be used, such as time derivation, spatial filtering and statistical evaluations of several data sets.

1. A method for dynamic reservoir characterization by generating and visually presenting a three-dimensional reservoir model defined by a data set of cells, each cell describing a geometric shape in space and time having an array of physical properties, where the method comprises the following steps:
a) computing a new physical property for each of said cells as a function of existing properties for same cells and/or adjacent cells;
b) if existing properties for same cells are used in said computing, then letting the new physical properties of these cells be a function of existing properties for another time step than the current time step for these same cells, and
c) presenting an image of at least a portion of the reservoir model on a display, said image comprises cells with a color defined by the value of the new physical property according to a predefined color map.

2. The method according to claim 1, wherein computing step a) is performed by applying a spatial filter kernel to each cell.

3. The method according to claim 1, wherein computing step a) also considers the corresponding cells in a series of different realizations of the same reservoir model.

4. The method according to claim 1, wherein the function in step b) is the time derivative of the existing property of the cell calculated by using two or more time steps to approximate the derivative.

5. The method according to claim 2, wherein the spatial filter kernel is a filter applied for enhancing spatial gradients in the image.

6. The method according to claim 1, wherein step c) is replaced by the step of filtering the cells of the reservoir model using thresholds based on the value of the new property and presenting the resulting volume of filtered cells on a display with color defined by any property.

7. A computer-readable storage medium containing executable instructions which, when executed by a processor, perform operations for dynamic reservoir characterization by generating and visually presenting a three-dimensional reservoir model defined by a data set of cells by performing the method defined in claims 1 to 6.
